(19) United States
(12) Patent Application Publication
(10) Pub. No.: US 2009/0260244 A1
(43) Pub. Date: Oct. 22, 2009

(54) Installation measurement device for ceramic and/or marble floor tiles

(76) Inventor: John A. Carbone, JR., Brick, NJ (US)

Correspondence Address: Charles I. Brodsky, Esq., 2 Bucks Lane, Marlboro, NJ, 07746, US

(21) Appl. No.: 12/082,999

(22) Filed: Apr. 17, 2008

(51) Int. Cl. G01B 1/00

(52) U.S. Cl. 33/527

(57) ABSTRACT

An installation measurement device for the cutting and trimming of ceramic and/or marble floor tiles, and ceiling tiles in forming an edge border, employing a Speed Square with a lockable, removable tape measure set against an edge of the square as a reference to which measurements are taken by stretching out the tape the desired distance.

### CROSS-REFERENCE TO RELATED APPLICATION

None.

### STATEMENT REGARDING FEDERALLY SPONSORED RESEARCH OR DEVELOPMENT

Research and development of this invention and Application have not been federally sponsored, and no rights are given under any Federal program.

### REFERENCE TO-A MICROFICHE APPENDIX

Not applicable

### BACKGROUND OF THE INVENTION

1. Field of the Invention

This invention relates to the installation of floor tiles, in general, and to an installation measurement device for installing ceramic and/or marble floor tiles, and ceiling tiles, in particular.

2. Description of the Related Art

Instructions are fairly common for homeowners and apartment dwellers to install vinyl floor tiles. One reason for this is that the vinyl tile is sufficiently resilient to allow it to be not only installed over virtually any underlying surface but it can be easily cut to size using a sharp utility knife or even a pair of ordinary scissors. Even for curves or irregular shapes, the tiles could be cut—warming them if needed to make that easier, especially when the tiles are being prepared for laying in a border space or around a pipe or other obstruction.

For such do-it-yourselfers, on the other hand, installing a ceramic or marble tile floor is quite a different story. While most homeowners and apartment dwellers possess (or can easily obtain) a utility knife or ordinary scissors, a wet saw equipped with a diamond-tipped blade is usually needed to cut or trim ceramic and marble tiles. That is usually not available, and requires a careful skill in using. Installing a ceramic or marble tile floor is then almost always left to the professional to accomplish.

As with the laying of vinyl floor tiles, once the center point of the room is found and marked, laying of the ceramic or marble tile starts at the center point, working out toward the walls. Utilizing inserts to keep the tiles evenly spaced, the laying proceeds towards the walls—although in many instances, the starting point is adjusted so that the rows against the walls would be approximately the same width on both sides of the room, and hopefully at least a half tile wide. With the installation of the ceramic or marble tile, the last measurement is usually measured inwardly from the edge of the wall, taken with a tape measure by the worker on his/her hands and knees. The appropriate tile is then cut on the wet saw either by the installer getting up off the floor, or by an assistant—frequently, just by the worker calling out to the assistant the measurement to be made when cutting the tile to be fitted in place. As will be readily acknowledged, however, for the installer to get up from the floor, and make the cut himself/herself, that is a time consuming process; secondly, he/she may only be approximating the width of the cut to be made, as by eyeballing it. Also, when the assistant hears the dimension to be cut, the actual cut made may end up being off by ¼″ or so, making the final laying inexact, or “off” when considered with the tile grout joint denominations.

As upsetting as this may be, however, the situation becomes much worse when the laying of the tile is to be on a diagonal, as in laying the floor in a diamond shape. Working with 13 inch ceramic tiles, for example, could put the installer on hands and knees the length of the diagonal away from the wall, almost 19 inches. With the fixer mud already on the floor, the installer is hesitant to put the hands and knees into the mud in leaning over to get an exact tape measure reading, and oftentimes “eyeballs” the distance from the wall. That could make the assistant's cut “off” even more, unnecessarily wasting a tile which could cost anywhere from $5.00 to $20.00.

Furthermore, the procedure could even be worse where the installer is doing the job himself/herself. There, after the measurement is taken, the installer gets up from his/her hands and knees, places the tape measure on a corner of the tile to be cut, makes a mark of the distance of the cut believed to be necessary, puts the tape measure down, scribes a line across the tile through the mark with a Speed Square or ruler, places the Speed Square or ruler back down, and either cuts the tile with a utility cutter himself/herself, or cuts it along that line on the wet saw. Experience has shown this to be a time consuming process, which is not shortened very much by handing the already-marked tile to the assistant to cut. And, the tile may still not be cut to exactly fit since the initial measurement was incorrect as the installer, most of time, is not leaning directly over the tile to look straight down in precisely reading the tape measurement. As will be appreciated by the skilled artisan, an improved way of doing this would be quite desirable—both from the standpoint of exactitude in the installation, and in the lessening of the time spent in measuring the ceramic or marble edge tiles. And, it would be desirable if this could all be carried out reducing the number of steps involved, and in a fashion so that the installer does not have to keep on getting up and down from the hands-and-knees position.

### OBJECTS OF THE INVENTION

It is an object of the present invention, therefore, to provide a new and improved installation measuring method for ceramic and/or marble floor tile and ceiling tile installations.

It is an object of the present invention, also, to provide an installation measurement device for accomplishing this which is both inexpensive and easy to use.

It is a further object of the invention to provide such a measurement device which can be used for other construction purposes, as well.

### SUMMARY OF THE INVENTION

As will become clear from the following description, the installation measurement device of the invention includes a conventional Speed Square, but one to which a lockable tape measure is removably secured. In a first embodiment of the invention, the tape measure is secured vertically against the square edge or lip of the Speed Square, while in a second embodiment, the tape measure is secured horizontally to the square edge of the Speed Square. Stretching the tape measure to the edge of the wall for a floor tile installation, and then locking it in place, provides the exact measurement for a tile to be cut no matter the distance to the wall, so that the handing of the combined measurement device to the assistant facilitates the exact dimension of the further tile to be cut in forming the wall's border or edge. No note need be taken of the specific measurement, and, no dimension needs to be called out to the assistant to cut. The combination Speed Square-Tape Measure is just handed over—and only one tool, rather than two tools are used; picking up, using and putting down first the tape and then the Speed Square will no longer be necessary.

In the second embodiment, a length of the square edge of the Speed Square is notched out to receive in its place, the leading edge of the tape measure when the tape is fully retrieved. Although in a preferred construction the length of the tape would be some 2-25 feet for use in the cutting of ceramic or marble floor tiles and ceiling tiles in this manner, a tape measure of any length could be employed (so that once freed from the Speed Square, the tape measure could be employed in any type of construction or carpentry measurement—as could the Speed Square). And, as will be apparent, different size measurement combinations could be had where desired, such as the incorporation of the tape measure with a Speed Square some 8 inches in length (i.e. “small”), or 12 inches in length (i.e. “large”).

And, although particularly useful in this installation of tile floors, it will be understood that the present invention in this manner could have usefulness to those who lay linoleum as well as to those who design and install countertops, as well as to be generally available to anyone in the construction field who would have an occasion to make angle installations in order to complete a job. For ceramic tile and marble tile floor laying, just pull out the tape to meet the wall, lock the tape in position, place the tape on a corner of the tile to mark the length, flip the tile along the square edge of the Speed Square and scribe a line through the mark, separate the tile from the Speed Square and then cut the tile along the scribed line using a hand cutter or wet saw.

### BRIEF DESCRIPTION OF THE DRAWINGS

These and other features of the present invention will be more clearly understood from a consideration of the following description, taken in connection with the accompanying drawings, in which:

FIG. 1 is a top view of a Speed Square for use with a first embodiment of the invention;

FIGS. 2 and 3 are pictorial views of the installation measurement device of the invention as employed with the Speed Square of FIG. 1;

FIG. 4 is a top view of a Speed Square for use with a second embodiment of the measurement device of the invention; and

FIG. 5 illustrates the second installation measurement device utilizing the Speed Square of FIG. 4.

### DETAILED DESCRIPTION OF THE INVENTION

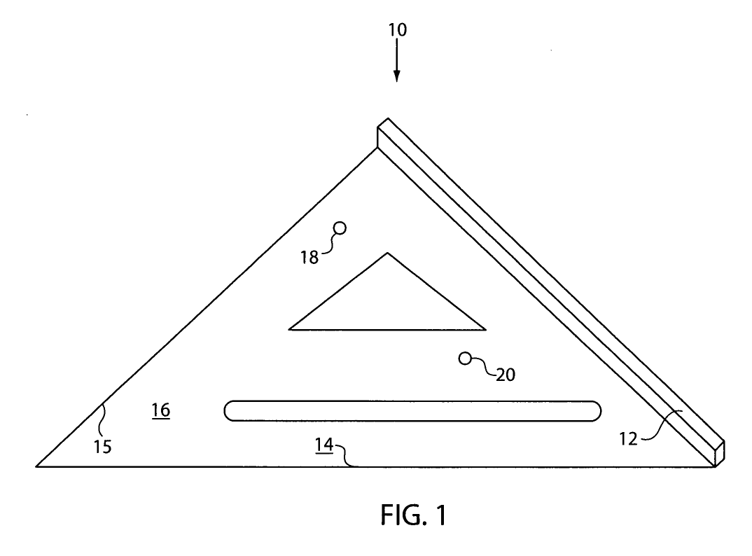

Referring to the Drawings, the conventional Speed Square 10 has a first or square edge lip 12 thicker from top to bottom than the adjacent second and third edges 14, 15. Such first edge 12, as will be appreciated, extends above and below its planar surface 16. FIG. 1 illustrates a pair of couplings 18, 20 to which a lockable tape measure may be removably secured. The Speed Square 10 may be of a plastic fabrication, and a tape measure to be secured with the Speed Square according to the invention may have a metallic casing. The length of the tape storable in the casing would be between 2 and 3 feet. The tip at the front end of the withdrawable tape would extend perpendicularly down from the tape as is well known, and would align with the square edge 12 at its outside facing surface.

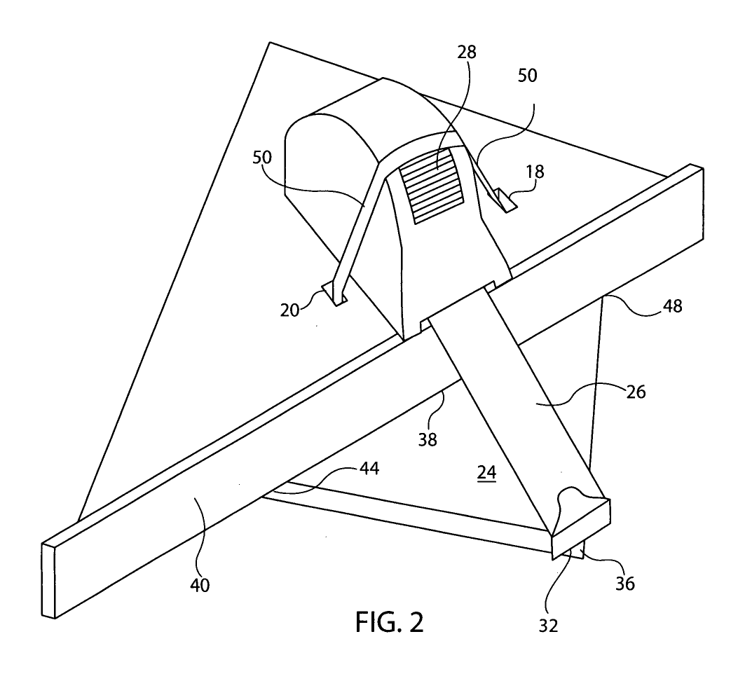

FIG. 2 illustrates the marking of a ceramic or marble tile 24 to be cut at the distance to which a measurement has been taken from the wall to the corner of a diagonally cut tile against which the tile 24 is to be placed. The tape 26 will be understood to be fixed in place at whatever the distance might be by depressing a lock 28 on the tape measure 30 in typical fashion. The front tip 32 of the tape 26 abuts the corner 36 of the tile 24. The mark made on the tile 24 is shown at 38, against the outside facing surface 40 of the square edge 12. Other corners of the ceramic tile are identified by reference numerals 44, 46 and 48, with corners 44 and 48 being shown in FIG. 2. Any appropriate removable securement of the tape measure 30 to the couplings 18, 20 may be utilized—with a strap 50, for example,just being shown for illustrative purposes in FIG. 2 spanning through the couplings 18, 20. As indicated, the mark 38 is made on the tile 24 adjacent the bottom of the square edge 12.

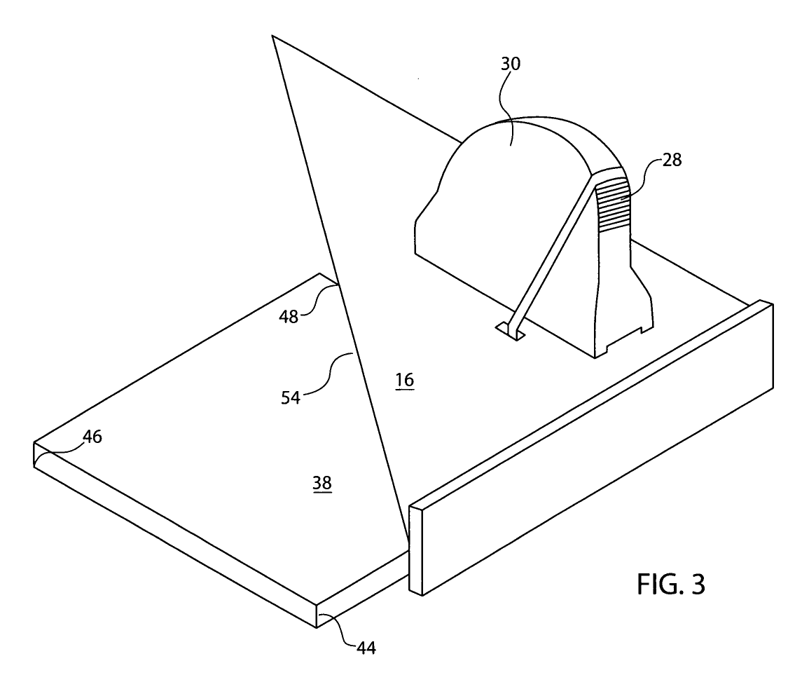

In accordance with the invention, as shown in FIG. 3, the Speed Square 10 is then rotated or flipped 90° so that the edge surface 52 of the tile 24 in FIG. 2 rests against the inside facing surface of the square edge 12, below its planar surface 16. The corner 36 is then below the surface 16, and the tile corner 46 appears. A line 54 can then be easily scribed through the mark 38 made on the tile 24 between the corners 44, 48 at the exact dimension needed. The tile 24 could then be removed from the measurement device to be cut along the line 54 simply with a hand cutter or wet saw. As will be readily understood in this manner, only one tool—that of the invention—instead of the two tools (i.e., the separate tape measure and the Speed Square), is required. No need exists to pick up one tool and use it, then put it down and use the other, resulting in a time savings for the worker. More importantly, an exact, precise measurement is obtained, whether it be the approximate 3 inch measurement shown in FIG. 2 for the small tile shown, or whether it be 4 inches, 5 inches, 6 inches or more for a larger tile. As will be appreciated, all that really needs to be done with the installation measurement device of the invention is to stretch out the tape, lock it in place, and then hand the measurement device to the assistant to scribe the line and make the cut. A precise distance cut is made, in a quicker manner, utilizing one tool instead of two. And as will be apparent, after all the required tile cuttings on the diagonals are done, the tape measure can be detached from the Speed Square and the 2 tools used separately for their usual purposes (especially where the tape is not restricted to the 2-3 foot length serving the invention).

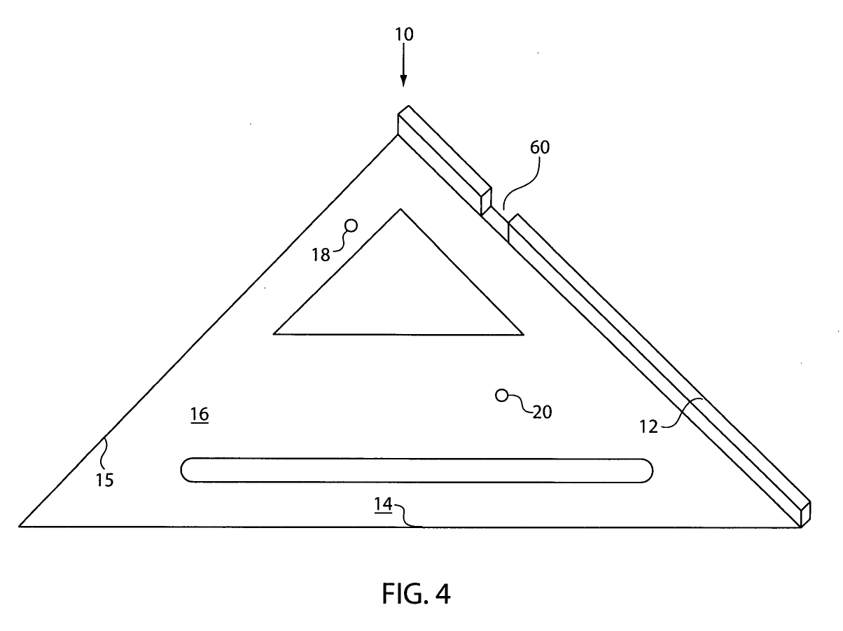

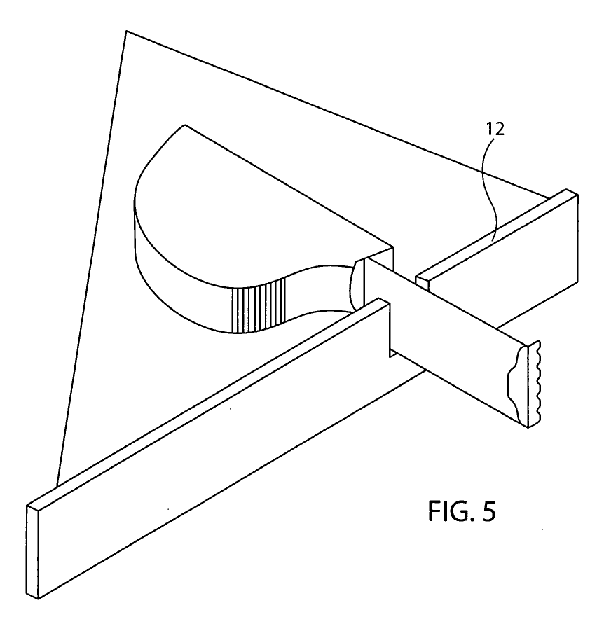

The installation measurement device of FIG. 5 operates the same as that of FIG. 2, except for the fact that the lockable tape measure 30 lays flat against the surface 16 of the Speed Square 10, instead of perpendicular to it as in FIG. 2. In FIG. 4, a notch 60 is cut into the square edge 12 through which the tip of the tape 26 extends in being stretched out. Once more, the stretching is from the wall to the corner of the nearest tile already laid to which the new tile is to be placed at the 45° angle (or other diagonal to which the floor is being laid). FIG. 5 shows the markings of the distance to be cut in a manner analogous to that of FIG. 2.

While there have been described what are considered to be preferred embodiments of the present invention, it will be readily appreciated by those skilled in the art that modifications can be made without departing from the scope of the teachings herein of always precisely cutting the length of a tile to be fit when the tile is being laid at an angle, regardless of what the distance may be, and totally independent of the installer looking at the distance measured on the tape, noting it, calling it out, or doing anything with it. All that is required is that the tape be locked at the required length, so that the tile to be cut for placement can be marked, and then lined on the Speed Square with which the tape measure is being used. And, while the present invention has been described in the context of cutting tiles for laying at angles, the measurement device of the invention could still be used for general construction work simply by detaching the tape measure from its couplings 18, 20 to the Speed Square. If that were to be an option for the worker, then the tape measure of the invention could be of other than the 2-25 feet employed for the laying of tile in a diagonal, so that the tape measure could be used in other general type work. Additionally, whereas the invention has been particularly described in the context specifically of the laying of floor tile, it could be used instead,in the laying of parquet floors as well as with ceiling tiles—even in woodworking—in fact, any place, where it would be desirable to install precisely cut pieces at precise angles in an installation. For at least such reasons, therefore, resort should be had to the claims appended hereto for a true understanding of the scope of the invention.

I claim:

1. An installation measurement device for use in the cutting of ceramic tiles, marble tiles or ceiling tiles to be fitted together at a diagonal comprising:
a Speed Square having a planar surface defined by a first edge extending above and below said surface, and by second and third edges joining together at a point and at opposing end points of said first edge;
a tape measure securable with said planar surface oriented for a tape to be drawn outwardly from said tape measure with respect to said first edge of said Speed Square; and
means for locking said tape measure to secure any length of tape withdrawn from said tape measure at any desired distance.

2. The installation measurement device of claim 1 wherein said Speed Square is of a plastic composition.

3. The installation measurement device of claim 1 wherein said first edge of said Speed Square extends above and below said planar surface a length to support the thickness of a ceramic tile, marble tile or ceiling tile to be cut.

4. The installation measurement device of claim 3 wherein said first and third edges of said Speed Square are of a substantial 8 inch length.

5. The installation measurement device of claim 3 wherein said first and third edges of said Speed Square are of a substantial 12 inch length.

6. The installation measurement device of claim 1 wherein said tape measure includes a casing of metallic composition.

7. The installation measurement device of claim 3 wherein said tape measure encloses a tape of length 2 feet-25 feet.

8. The installation measurement device of claim 7 wherein said first edge of said Speed Square extends above and below said planar surface a length to support the thickness of a ceramic tile, marble tile or ceiling tile to be cut.

9. The installation measurement device of claim 3 wherein said tape measure is removably detachable from said planar surface of said Speed Square.

10. The installation measurement device of claim 1 wherein said tape is drawn outwardly through a notch in said first edge of said Speed Square.

11. The installation measurement device of claim 10 wherein said tape measure encloses a tape of length 2 feet-25 feet.

12. The installation measurement device of claim 11 wherein said first edge of said Speed Square extends above and below said planar surface a length to support the thickness of a ceramic tile, marble tile or ceiling tile to be cut.

13. The installation measurement device of claim 12 wherein said tape measure is removably detachable from said planar surface of said Speed Square.

14. The installation measurement device of claim 13 wherein said Speed Square is of a plastic composition and wherein said tape measure includes a casing of metallic composition.
